(19) United States
(12) Patent Application Publication
(10) Pub. No.: US 2022/0112698 A1
(43) Pub. Date: Apr. 14, 2022

(54) A TESTING DEVICE FOR BACKFLOW PREVENTION DEVICES

(71) Applicant: Gould Instruments Pty Ltd, Mundingburra (AU)

(72) Inventor: Brian Gould, Mundingburra (AU)

(73) Assignee: Gould Instruments Pty Ltd, Mundingburra (AU)

(21) Appl. No.: 17/294,986

(22) PCT Filed: Nov. 19, 2019
(86) PCT No.: PCT/AU2019/051271

§ 371 Date: May 18, 2021

(30) Foreign Application Priority Data
Nov. 19, 2018 (AU) 2018904410

(51) Int. Cl. E03B 7/07; G01M 3/28

(52) U.S. Cl. CPC E03B 7/078; G01M 3/2876; E03B 7/077

(57) ABSTRACT

A testing device for backflow prevention devices, the testing device comprising a first connection portion adapted for connection to one of a high pressure side or a low pressure side of a backflow prevention device, a second connection portion adapted for connection to the other of the high pressure side or the low pressure side of the backflow pressure device, and an electronic differential pressure gauge positioned in fluid communication with the first connection portion and the second connection portion and adapted to measure the differential pressure between the high pressure side and the low pressure side of the backflow prevention device.

### TECHNICAL FIELD

The present invention relates to a testing device for backflow prevention devices. In particular, the present invention relates to a testing device for measuring the differential pressure in backflow prevention devices.

### BACKGROUND ART

Backflow prevention devices are typically used to protect water supply systems (and particularly industrial water supply systems) from contamination or pollution due to backflow. In conventional water supply systems, water is maintained at an elevated pressure to enable water to flow from a water outlet. Water pressure may fail or be reduced when a water main bursts, pipes freeze, or there is unexpectedly high demand on the water system (for example, when several fire hydrants are opened). This reduction in pressure in the pipe may allow water from the soil, from storage, or from other sources to be drawn up into the system, thereby contaminating the water supply. Strict safety requirements exist for the dumping of contaminated water, making disposing thereof an onerous task, as well as representing a waste of water.

Numerous backflow prevention devices have been developed over the years. Typically, these devices include a valve member that separates a relatively high pressure side of the device from a relatively low pressure side of the device. Common backflow prevention devices include atmospheric vacuum breakers (AVB), check valves, chemigation valves, double check valves, or double check valve assemblies (DCVA), pressure vacuum breaker assemblies (PVB), reduced pressure zone devices (RPZ), spill resistant pressure vacuum breaker assemblies (SPVB) or vacuum breakers.

Backflow prevention devices require regular testing to ensure that they are operating effectively. Typically, backflow prevention devices are tested by measuring the pressure differential between the high pressure and low pressure sides of the device. In general, the smaller the pressure differential, the less likely it is that the backflow prevention device is operating effectively. In Australia, the testing of backflow prevention devices is covered by Australian Standard AS2845.3.

Conventional devices for testing backflow prevention devices are typically mechanical in nature, making them prone to corrosion and failure. In addition, mechanical testing devices are, by their very nature, relatively inaccurate, and typically have a margin of error of ±3% of full scale deflection (FSD) of a pressure gauge.

Thus, there would be an advantage if it were possible to provide a testing device for backflow prevention devices that provided improved measurement accuracy as well as having improved reliability and service life.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a testing device for backflow prevention devices, which may at least partially overcome at least one of the abovementioned disadvantages or provide the consumer with a useful or commercial choice.

With the foregoing in view, the present invention in a first aspect, resides broadly in a fluid pressure measurement device, the fluid pressure measurement device comprising a first connection portion adapted for connection to one of a high pressure side or a low pressure side of a fluid carrying conduit, a second connection portion adapted for connection to the other of the high pressure side or the low pressure side of the fluid carrying conduit, and an electronic differential pressure gauge positioned in fluid communication with the first connection portion and the second connection portion and adapted to measure the differential pressure between the high pressure side and the low pressure side of the fluid carrying conduit.

The fluid carrying conduit may be of any suitable form. For instance, the fluid carrying conduit may comprise a conduit of a backflow prevention device, a conduit of a fire sprinkler system and the like.

In a second aspect, the invention resides broadly in a testing device for backflow prevention devices, the testing device comprising a first connection portion adapted for connection to one of a high pressure side or a low pressure side of a backflow prevention device, a second connection portion adapted for connection to the other of the high pressure side or the low pressure side of the backflow pressure device, and an electronic differential pressure gauge positioned in fluid communication with the first connection portion and the second connection portion and adapted to measure the differential pressure between the high pressure side and the low pressure side of the backflow prevention device.

The first connection portion may be of any suitable form and may be connected to the backflow prevention device in any suitable manner. Preferably, however, the backflow prevention device may be provided with one or more test cocks to which the first connection portion may be adapted for connection. The first connection portion may be adapted for fixed or removable connection to the backflow prevention device. Preferably, the first connection portion may be adapted for removable connection to the backflow prevention device, such that the first connection portion need only be connected to the backflow prevention device when testing of the backflow prevention device is required.

Similarly, the second connection portion may be of any suitable form and may be connected to the backflow prevention device in any suitable manner. Preferably, however, the backflow prevention device may be provided with one or more test cocks to which the second connection portion may be adapted for connection. The second connection portion may be adapted for fixed or removable connection to the backflow prevention device. Preferably, the second connection portion may be adapted for removable connection to the backflow prevention device, such that the second connection portion need only be connected to the backflow prevention device when testing of the backflow prevention device is required.

The first connection portion and the second connection portion may be connected to the backflow prevention device in any suitable manner. In some embodiments of the invention, the first connection portion and/or the second connection portion may be connected directly to the backflow prevention device. Alternatively, the first connection portion and/or the second connection portion may be connected to the backflow prevention device via one or more intermediate connection members.

The one or more intermediate connection members may be of any suitable form, although in a preferred embodiment of the invention, the one or more intermediate connection members may comprise one or more conduits adapted to extend between the backflow prevention device (or, more specifically, the test cocks of the backflow prevention device) and the first connection portion and/or the second connection portion.

The one or more intermediate connection members may be of any suitable form. In some embodiments of the invention, the one or more conduits may comprise pipes, hoses or the like, or a combination thereof.

In a most preferred embodiment of the invention, a first intermediate connection member is positioned between the backflow prevention device and the first connection portion and a second intermediate connection member is positioned between the backflow prevention device and the second connection portion.

Preferably, opposed ends of the intermediate connection members (where present) and the first connection portion and the second connection portion may be provided with connection fittings adapted to facilitate connection of the testing device to the backflow prevention device. Any suitable connection fittings may be provided, such as snap fittings, screw fittings, hose connections (including quick release hose connections) or the like, or any suitable combination thereof. It is envisaged that different backflow prevention devices may be provided with different connection fittings, in terms of the type of connection fitting or the size of the connection fitting (e.g. the diameter, thread type etc.). In this embodiment of the invention, it is envisaged that the connection fittings on the first connection, second connection portion and/or the intermediate connection members may be able to be removed and replaced with different connection fittings more suited to the particular situation. Alternatively, one or more converter members may be provided, the one or more converter members adapted to be located between the test cocks of the backflow prevention device and the intermediate connection members (or the first connection portion and the second connection portion) in order to allow connection of the testing device to the backflow prevention device if the connection fittings of the backflow prevention device and the connection fittings of the testing device are not compatible with one another.

It is envisaged that, once the testing device is connected to the backflow prevention device, fluid from the low pressure side of the device and the high pressure side of the device may be permitted to flow into the testing device. This may be achieved by, for instance, actuating one or more valves to allow fluid to flow from the backflow prevention device to the testing device. More specifically, fluid flows from the backflow prevention device into the testing device through the first connection portion and the second connection portion.

At least a portion of the fluid entering the testing device through the first connection portion and the second connection portion may be directed into a measurement portion of the testing device. The measurement portion may be of any suitable form. However, in a preferred embodiment of the invention, the electronic differential pressure gauge may be associated with the measurement portion. Thus, it is envisaged that the differential pressure between the high pressure side of the backflow prevention device and the low pressure side of the backflow prevention device may be measured in the measurement portion of the testing device.

In a preferred embodiment of the invention, the measurement portion may comprise a conduit (such as a pipe) in fluid communication with the first connection portion and the second connection portion. Preferably, fluid flowing into the measurement portion from the first connection member may enter the measurement portion from a first inlet of the measurement portion, while fluid flowing into the measurement portion from the second connection member may enter the measurement portion from a second inlet of the measurement portion. Preferably, the first inlet of the measurement portion and the second inlet of the measurement portion may be provided at opposed ends of the measurement portion.

It is envisaged that the electronic differential pressure gauge may be provided with one or more pressure transducers, and in particular one or more differential pressure transducers. Preferably, the one or more pressure transducers may be located in the measurement portion. The one or more pressure transducers may be located in the measurement portion such that fluid entering the measurement portion through the first inlet is substantially precluded from flowing past the one or more pressure transducers towards the second inlet. Similarly, fluid entering the measurement portion through the second inlet may be substantially precluded from flowing past the one or more pressure transducers towards the first inlet. In this way, the one or more pressure transducers may be subject, on a first side thereof, to the pressure of the fluid from the low pressure side of the backflow prevention device and, on a second side thereof, to the pressure of the fluid from the high pressure side of the backflow prevention device.

The construction and operation of the one or more pressure transducers and the electronic differential pressure gauge is conventional, and no further discussion of this is required, except to say that one or more additional sensors may be associated with the electronic differential pressure gauge. The one or more additional sensors may be adapted to measure one or more additional properties of the fluid from the high pressure side and/or low pressure side of the backflow prevention device.

Any additional properties of the fluid may be measured, such as, but not limited to, temperature, pH, Eh, dissolved oxygen content, flow velocity and the like, or any suitable combination thereof.

Preferably, measurements taken by the one or more pressure transducers (or other sensors, if present) may be electronically communicated to a calculation portion of the electronic differential pressure gauge. The calculation portion may perform one or more calculations in order to provide a value for a particular parameter, or may simply convert the data received from the pressure transducer (or other sensors) into readable format. Thus, it is envisaged that the electronic differential pressure gauge may include a display (and particularly, an electronic display) on which the measured differential pressure (and the one or more additional measured properties of the fluid) may be displayed. Alternatively (or in addition to), the electronic differential pressure gauge may electronically communicate the measured differential pressure (and the one or more additional measured properties of the fluid) to an electronic device in electronic communication with the electronic differential pressure gauge. The electronic device may be of any suitable form, such as a computer, computer tablet, smart watch, mobile telephone, DCS or the like, or any suitable combination thereof. The electronic device may be physically connected to the electronic differential pressure gauge (such as by one or more wires, cables or the like) or may be remote to the electronic differential pressure gauge and may be in wireless communication therewith. Thus, in some embodiments of the invention the electronic differential pressure gauge may electronically communicate the measured differential pressure (and the one or more additional measured properties of the fluid) to an electronic device via Bluetooth, Wi-Fi or the like.

In some embodiments of the invention, the testing device may be provided with a wireless connection device. Preferably, the wireless connection device is in electronic communication with the electronic differential pressure gauge. The wireless connection device may be of any suitable form, and it will be understood that the purpose of the wireless connection device is to provide a wireless connection between the electronic device and the electronic differential pressure gauge. In this way, a user may communicate or transmit the measured differential pressure (and the one or more additional measured properties of the fluid) to the electronic device. Thus, in some embodiments of the invention, the wireless connection device may comprise a router. Any suitable router may be used, and it will be understood that the choice of router may be dependent on a number of factors, such as the nature of the measured differential pressures to be transmitted, the specifications of the electronic differential pressure gauge, the number of electronic devices expected to connect to the electronic differential pressure gauge and so on.

The electronic differential pressure gauge and the wireless connection device may be in electronic communication with one another in any suitable manner. For instance, the electronic differential pressure gauge and the wireless connection device may be physically connected to one another (such as by one or more wires, cords or the like) or may be wirelessly connected to one another (such as by Wi-Fi, Bluetooth or the like).

As previously stated, the wireless connection device is adapted to allow one or more electronic devices to receive the measured differential pressures from the electronic differential pressure gauge. The one or more electronic devices may be of any suitable form. However, in a preferred embodiment of the invention, the one or more electronic devices may comprise desktop computers, laptop computers, computer tablets, mobile telephones or the like. It is envisaged that the one or more electronic devices may connect wirelessly to the electronic differential pressure gauge via the wireless connection device using any suitable technique. For instance, the one or more electronic devices may connect to the electronic differential pressure gauge via the wireless connection device using Wi-Fi, Bluetooth or the like.

The testing device may further comprise one or more transmitting and receiving devices. Any suitable transmitting or receiving devices may be provided, such as a Wi-Fi hotspot, antenna or the like. In a preferred embodiment of the invention, the transmitting and receiving device may comprise one or more wireless access points (AP). Preferably, the AP is in electronic communication with the wireless communication device. In some embodiments of the invention, the AP may be formed integrally with the wireless communication device. It is envisaged that the AP may be provided in order to enhance the transmission and reception of electronic signals between the testing device and the one or more electronic devices associated with the users.

In other embodiments of the invention, a passive access point (AP) may also be provided. The passive AP may be provided so as to allow an electronic device with a static IP address to receive the measured differential pressures from the electronic differential pressure gauge. The passive AP may also be provided so as to detect the presence of electronic devices having a media access control (MAC) address.

In one embodiment of the invention, an identifier may be associated with the backflow prevention device. The identifier may be of any suitable form. For instance, the identifier may include a serial number or the like. More preferably, the identifier may be in the form of an electronically readable element. Any suitable electronically readable element may be used. For instance, the electronically readable element may include a barcode, such as a one dimensional barcode or a two dimensional barcode. In some embodiments of the invention, the electronically readable element may be a Quick Response (QR) code, while in other embodiments of the invention, the electronically readable element may comprise an RFID tag.

It is envisaged that, in use, a user may enter the identifier into an electronic device. The identifier may be entered manually by the user, or may be entered by scanning the electronically readable element using the electronic device (for instance, using a camera associated with the electronic device).

Preferably, the identifier may be entered into an electronic backflow prevention device testing system. More specifically, the identifier may be entered into a user interface associated with an electronic backflow prevention device testing system. The user interface may be provided on a website accessed via the electronic device or may be in the form of an app downloaded to the electronic device.

In a preferred embodiment of the invention, the electronic backflow prevention device testing system includes, or is associated with, a server. In a preferred embodiment of the invention, the server may be associated with an electronic database of one or more backflow prevention devices. Preferably, the electronic database includes an electronic record associated with each of the one or more backflow prevention devices. It is envisaged that the electronic record may include one or more pieces of information regarding each of the one or more backflow prevention devices, such as, but not limited to, location of the backflow prevention device, type of backflow prevention device, preferred and/or required operating pressures, previous test measurements, dates of previous test measurements, details of previous testers and so on.

In a preferred embodiment of the invention, each backflow prevention device in the electronic database is associated with a unique identifier, such that, when the identifier associated with a particular backflow prevention device is entered into the electronic backflow prevention device testing system, the electronic record associated with the backflow prevention device associated with that identifier may be retrieved and/or updated.

In use, it is envisaged that the testing device may be connected to a backflow prevention device in order to measure the differential fluid pressure in the backflow pressure device. A user may enter the identifier associated with the backflow prevention device using the electronic device in order to access the electronic record in the electronic database regarding the backflow prevention device (identified in the electronic database by the identifier).

It is envisaged that the electronic device may be in electronic communication with the testing device, such that the differential pressure measurements measured by the testing device may be electronically communicated to the electronic device. More preferably, the differential pressure measurements measured by the testing device may be electronically communicated to the user interface of the electronic backflow prevention device testing system on the electronic device. Thus, in one embodiment, it is envisaged that the electronic backflow prevention device testing system may automatically populate the user interface with the differential pressure measurements received from the testing device. In this way, a user is not required to manually record the measurements.

The differential pressure measurements measured by the testing device may be automatically added to the electronic record for the backflow prevention device, and an updated electronic record may be written to the electronic database. Alternatively, the user may be required to review the differential pressure measurements in the user interface on the electronic device prior to the differential pressure measurements being included in the electronic record for the backflow prevention device. In this embodiment, it is envisaged that the user may be required to accept the differential pressure measurements prior to the generation of an updated electronic record for the backflow prevention device being written to the electronic database.

The electronic differential pressure gauge may be powered using any suitable power source. In some embodiments of the invention, the electronic differential pressure gauge may be associated with one or more batteries adapted to power the electronic differential pressure gauge. Alternatively, electronic differential pressure gauge may require being connected to an external power source, such as mains power, a generator or the like.

The testing device may be provided with an outlet portion. Preferably, the outlet portion may be provided in fluid communication with both the first connection portion and the second connection portion. Thus, it is envisaged that fluid entering the testing device through both the first connection portion and the second connection portion may exit the testing device through the outlet portion. Preferably, the first connection portion may be connected to the outlet portion by one or more conduits. Similarly, the second connection portion and the outlet portion may be connected to one another by one or more conduits. Fluid entering the testing device through the first connection portion may be discharged from the outlet portion separately to fluid entering the testing device through the second connection portion. Alternatively, fluid entering the testing device through the first and second connection portions may be at least partially combined prior to discharge through the outlet portion.

In some embodiments of the invention, one or more valves may be provided between the first connection portion and the outlet portion, and between the second connection portion and the outlet portion. The one or more valves may be opened and closed as required to allow or prevent fluid entering the testing device through the first connection portion and/or the second connection to exit the testing device through the outlet portion.

The outlet portion may be of any suitable form. For instance the outlet portion may be provided with one or more outlets through which fluid may be discharged from the testing device. Most preferably, a single outlet may be provided.

In some embodiments of the invention, the outlet may be adapted for connection to the backflow prevention device. In this way, fluid removed from the backflow prevention device for testing in the testing device may be returned to the backflow prevention device. As previously stated, the backflow prevention device may be provided with one or more test cocks to which the outlet portion may be adapted for connection. The outlet portion may be adapted for fixed or removable connection to the backflow prevention device. Preferably, the outlet portion may be adapted for removable connection to the backflow prevention device, such that the outlet portion need only be connected to the backflow prevention device when testing of the backflow prevention device is required.

The outlet portion may be connected to the backflow prevention device in any suitable manner. In some embodiments of the invention, the outlet portion may be connected directly to the backflow prevention device. Alternatively, the outlet portion may be connected to the backflow prevention device via one or more intermediate connection members.

The one or more intermediate connection members may be of any suitable form, although in a preferred embodiment of the invention, the one or more intermediate connection members may comprise one or more conduits adapted to extend between the backflow prevention device (or, more specifically, the test cocks of the backflow prevention device) and the outlet portion.

The one or more intermediate connection members may be of any suitable form. In some embodiments of the invention, the one or more conduits may comprise pipes, hoses or the like, or a combination thereof.

Preferably, opposed ends of the intermediate connection members (where present) and the outlet portion may be provided with connection fittings adapted to facilitate connection of the testing device to the backflow prevention device. Any suitable connection fittings may be provided, such as snap fittings, screw fittings, hose connections (including quick release hose connections) or the like, or any suitable combination thereof. It is envisaged that different backflow prevention devices may be provided with different connection fittings, in terms of the type of connection fitting or the size of the connection fitting (e.g. the diameter, thread type etc.). In this embodiment of the invention, it is envisaged that the connection fittings on the outlet portion and/or the intermediate connection members may be able to be removed and replaced with different connection fittings more suited to the particular situation. Alternatively, one or more converter members may be provided, the one or more converter members adapted to be located between the test cocks of the backflow prevention device and the intermediate connection members (or the outlet portion) in order to allow connection of the testing device to the backflow prevention device if the connection fittings of the backflow prevention device and the connection fittings of the testing device are not compatible with one another.

In a preferred embodiment of the invention, the testing device may further comprise a pressure gauge. Preferably, the pressure gauge may be associated with the first connection portion. More preferably, the pressure gauge may be associated with the first connection portion and adapted to measure fluid pressure at the side of the backflow prevention device to which the first connection portion is attached. The pressure gauge may be an analogue or digital pressure gauge.

The testing device may be of unitary construction or may be fabricated from two or more portions adapted for connection to one another using any suitable technique. It is envisaged that these connection techniques will be conventional, and no further discussion of these is required.

The testing device may be fabricated from any suitable material or combination of materials, such as metal, polymer, fibreglass or the like. Preferably, the testing device (and particularly the conduits through which fluid flows) may be fabricated from a relatively corrosion-resistant material, such as brass or stainless steel.

In a third aspect, the invention resides broadly in a testing device for Pitot tubes, the testing device comprising a first connection portion adapted for connection to one of a high pressure side or a low pressure side of a Pitot tube, a second connection portion adapted for connection to the other of the high pressure side or the low pressure side of the Pitot tube, and an electronic differential pressure gauge positioned in fluid communication with the first connection portion and the second connection portion and adapted to measure the differential pressure between the high pressure side and the low pressure side of the Pitot tube.

In a preferred embodiment of the invention, the Pitot tube is an averaging Pitot tube. Even more preferably, the Pitot tube is an annubar averaging Pitot tube. Still more preferably, the Pitot tube is provided in the form of an insertion probe.

It will be understood that an annubar averaging Pitot tube may be used in situations in which it is not possible to access pipework in order to measure fluid flow. Such situations may arise when it is necessary to measure fluid flow in, for instance, fire sprinkler systems.

The first connection portion may be of any suitable form and may be connected to the Pitot tube in any suitable manner. Preferably, however, the Pitot tube may be provided with one or more test cocks to which the first connection portion may be adapted for connection. The first connection portion may be adapted for fixed or removable connection to the Pitot tube. Preferably, the first connection portion may be adapted for removable connection to the Pitot tube, such that the first connection portion need only be connected to the Pitot tube when testing of the fluid carrying device (such as a fire sprinkler system) is required.

Similarly, the second connection portion may be of any suitable form and may be connected to the Pitot tube in any suitable manner. Preferably, however, the Pitot tube may be provided with one or more test cocks to which the second connection portion may be adapted for connection. The second connection portion may be adapted for fixed or removable connection to the Pitot tube. Preferably, the second connection portion may be adapted for removable connection to the Pitot tube, such that the second connection portion need only be connected to the backflow prevention device when testing of the fluid carrying device (such as a fire sprinkler system) is required.

The first connection portion and the second connection portion may be connected to the Pitot tube in any suitable manner. In some embodiments of the invention, the first connection portion and/or the second connection portion may be connected directly to the Pitot tube. Alternatively, the first connection portion and/or the second connection portion may be connected to the Pitot tube via one or more intermediate connection members.

The one or more intermediate connection members may be of any suitable form, although in a preferred embodiment of the invention, the one or more intermediate connection members may comprise one or more conduits adapted to extend between the Pitot tube and the first connection portion and/or the second connection portion.

The one or more intermediate connection members may be of any suitable form. In some embodiments of the invention, the one or more conduits may comprise pipes, hoses or the like, or a combination thereof.

In a most preferred embodiment of the invention, a first intermediate connection member is positioned between the Pitot tube and the first connection portion and a second intermediate connection member is positioned between the Pitot tube and the second connection portion.

Preferably, opposed ends of the intermediate connection members (where present) and the first connection portion and the second connection portion may be provided with connection fittings adapted to facilitate connection of the testing device to the Pitot tube. Any suitable connection fittings may be provided, such as snap fittings, screw fittings, hose connections (including quick release hose connections) or the like, or any suitable combination thereof. It is envisaged that different Pitot tubes may be provided with different connection fittings, in terms of the type of connection fitting or the size of the connection fitting (e.g. the diameter, thread type etc.). In this embodiment of the invention, it is envisaged that the connection fittings on the first connection, second connection portion and/or the intermediate connection members may be able to be removed and replaced with different connection fittings more suited to the particular situation. Alternatively, one or more converter members may be provided, the one or more converter members adapted to be located between the test cocks of the Pitot tube and the intermediate connection members (or the first connection portion and the second connection portion) in order to allow connection of the testing device to the Pitot tube if the connection fittings of the Pitot tube and the connection fittings of the testing device are not compatible with one another.

It is envisaged that, once the testing device is connected to the Pitot tube, fluid from the low pressure side of the Pitot tube and the high pressure side of the Pitot tube may be permitted to flow into the testing device. This may be achieved by, for instance, actuating one or more valves to allow fluid to flow from the Pitot tube to the testing device. More specifically, fluid may flow from the Pitot tube into the testing device through the first connection portion and the second connection portion.

At least a portion of the fluid entering the testing device through the first connection portion and the second connection portion may be directed into a measurement portion of the testing device. The measurement portion may be of any suitable form. However, in a preferred embodiment of the invention, the electronic differential pressure gauge may be associated with the measurement portion. Thus, it is envisaged that the differential pressure between the high pressure side of the Pitot tube and the low pressure side of the Pitot tube may be measured in the measurement portion of the testing device.

In a preferred embodiment of the invention, the measurement portion may comprise a conduit (such as a pipe) in fluid communication with the first connection portion and the second connection portion. Preferably, fluid flowing into the measurement portion from the first connection member may enter the measurement portion from a first inlet of the measurement portion, while fluid flowing into the measurement portion from the second connection member may enter the measurement portion from a second inlet of the measurement portion. Preferably, the first inlet of the measurement portion and the second inlet of the measurement portion may be provided at opposed ends of the measurement portion.

It is envisaged that the electronic differential pressure gauge may be provided with one or more pressure transducers, and in particular one or more differential pressure transducers. Preferably, the one or more pressure transducers may be located in the measurement portion. The one or more pressure transducers may be located in the measurement portion such that fluid entering the measurement portion through the first inlet is substantially precluded from flowing past the one or more pressure transducers towards the second inlet. Similarly, fluid entering the measurement portion through the second inlet may be substantially precluded from flowing past the one or more pressure transducers towards the first inlet. In this way, the one or more pressure transducers may be subject, on a first side thereof, to the pressure of the fluid from the low pressure side of the Pitot tube and, on a second side thereof, to the pressure of the fluid from the high pressure side of the Pitot tube.

The construction and operation of the one or more pressure transducers and the electronic differential pressure gauge is conventional, and no further discussion of this is required, except to say that one or more additional sensors may be associated with the electronic differential pressure gauge. The one or more additional sensors may be adapted to measure one or more additional properties of the fluid from the high pressure side and/or low pressure side of the Pitot tube.

Any additional properties of the fluid may be measured, such as, but not limited to, temperature, pH, Eh, dissolved oxygen content, flow velocity and the like, or any suitable combination thereof.

Preferably, measurements taken by the one or more pressure transducers (or other sensors, if present) may be electronically communicated to a calculation portion of the electronic differential pressure gauge. The calculation portion may perform one or more calculations in order to provide a value for a particular parameter, or may simply convert the data received from the pressure transducer (or other sensors) into readable format. In other embodiments of the invention, the calculation portion may convert the pressure differential measurements into another measurement. For instance, the calculation portion may convert the pressure differential measurements into units of measurement such as Pascals, Kilopascals, Torr, Inches of Mercury or the like, or a combination thereof. Any suitable range of the units of measurement may be used, although in a specific embodiment of the invention, the range of the units of measurement may be 0-100 kPa or 0-30 inHg.

It is envisaged that the electronic differential pressure gauge may include a display (and particularly, an electronic display) on which the measured differential pressure (and the one or more additional measured properties of the fluid) and/or the converted pressure differential measurements may be displayed.

In some embodiments of the invention, the calculation portion may convert the differential pressure measurements into a different parameter. The differential pressure measurements may be converted into any suitable parameter, although in a preferred embodiment of the invention, the differential pressure measurements may be converted into flowrate. Thus, the calculation portion may convert the differential pressure measurements into the flowrate of fluid within the fluid carrying device. The conversion to flowrate may be directly from the differential pressure measurements, or may be from the differential pressure measurements when converted into the units of measurement.

In another embodiment of the invention, a user may be required to convert the converted units of measurement into flowrate, either manually by using a chart or graph, or by using a computer or calculator.

The electronic differential pressure gauge may be powered using any suitable power source. In some embodiments of the invention, the electronic differential pressure gauge may be associated with one or more batteries adapted to power the electronic differential pressure gauge. Alternatively, electronic differential pressure gauge may require being connected to an external power source, such as mains power, a generator or the like.

The testing device may be provided with an outlet portion. Preferably, the outlet portion may be provided in fluid communication with both the first connection portion and the second connection portion. Thus, it is envisaged that fluid entering the testing device through both the first connection portion and the second connection portion may exit the testing device through the outlet portion. Preferably, the first connection portion may be connected to the outlet portion by one or more conduits. Similarly, the second connection portion and the outlet portion may be connected to one another by one or more conduits. Fluid entering the testing device through the first connection portion may be discharged from the outlet portion separately to fluid entering the testing device through the second connection portion. Alternatively, fluid entering the testing device through the first and second connection portions may be at least partially combined prior to discharge through the outlet portion.

In some embodiments of the invention, one or more valves may be provided between the first connection portion and the outlet portion, and between the second connection portion and the outlet portion. The one or more valves may be opened and closed as required to allow or prevent fluid entering the testing device through the first connection portion and/or the second connection to exit the testing device through the outlet portion.

The outlet portion may be of any suitable form. For instance the outlet portion may be provided with one or more outlets through which fluid may be discharged from the testing device. Most preferably, a single outlet may be provided.

In some embodiments of the invention, the outlet may be adapted for connection to the Pitot tube. In this way, fluid removed from the Pitot tube for testing in the testing device may be returned to the Pitot tube and therefore the fire sprinkler system. As previously stated, the Pitot tube may be provided with one or more test cocks to which the outlet portion may be adapted for connection. The outlet portion may be adapted for fixed or removable connection to the Pitot tube. Preferably, the outlet portion may be adapted for removable connection to the Pitot tube, such that the outlet portion need only be connected to the Pitot tube when testing of the Pitot tube is required.

The outlet portion may be connected to the Pitot tube in any suitable manner. In some embodiments of the invention, the outlet portion may be connected directly to the Pitot tube. Alternatively, the outlet portion may be connected to the Pitot tube via one or more intermediate connection members.

The one or more intermediate connection members may be of any suitable form, although in a preferred embodiment of the invention, the one or more intermediate connection members may comprise one or more conduits adapted to extend between the Pitot tube (or, more specifically, the test cocks of the Pitot tube) and the outlet portion.

The one or more intermediate connection members may be of any suitable form. In some embodiments of the invention, the one or more conduits may comprise pipes, hoses or the like, or a combination thereof.

Preferably, opposed ends of the intermediate connection members (where present) and the outlet portion may be provided with connection fittings adapted to facilitate connection of the testing device to the Pitot tube. Any suitable connection fittings may be provided, such as snap fittings, screw fittings, hose connections (including quick release hose connections) or the like, or any suitable combination thereof. It is envisaged that different backflow prevention devices may be provided with different connection fittings, in terms of the type of connection fitting or the size of the connection fitting (e.g. the diameter, thread type etc.). In this embodiment of the invention, it is envisaged that the connection fittings on the outlet portion and/or the intermediate connection members may be able to be removed and replaced with different connection fittings more suited to the particular situation. Alternatively, one or more converter members may be provided, the one or more converter members adapted to be located between the test cocks of the Pitot tube and the intermediate connection members (or the outlet portion) in order to allow connection of the testing device to the Pitot tube if the connection fittings of the Pitot tube and the connection fittings of the testing device are not compatible with one another.

The testing device may be of unitary construction or may be fabricated from two or more portions adapted for connection to one another using any suitable technique. It is envisaged that these connection techniques will be conventional, and no further discussion of these is required.

The testing device may be fabricated from any suitable material or combination of materials, such as metal, polymer, fibreglass or the like. Preferably, the testing device (and particularly the conduits through which fluid flows) may be fabricated from a relatively corrosion-resistant material, such as brass or stainless steel.

In a fourth aspect, the invention resides broadly in a method for monitoring fluid pressure in a backflow prevention device, the method including the steps of:
a) Connecting a testing device to the backflow prevention device, the testing device including an electronic differential pressure gauge;
b) Entering, using an electronic device associated with a user, an identifier associated with the backflow prevention device into an electronic backflow prevention device testing system;
c) Receiving, with the electronic device, one or more differential pressure measurements generated by the electronic differential pressure gauge;
d) Entering the one or more differential pressure measurements into an electronic record associated with the backflow prevention device to create an updated electronic record; and
e) Writing the updated electronic record to an electronic database associated with the electronic backflow prevention device testing system.

The present invention provides numerous advantages over the prior art. Firstly, in comparison to conventional mechanical devices with multiple moving parts, the present invention is more accurate, more reliable and has an improved service life (due to its corrosion resistance). Further, the use of a digital display removes parallax error, also improving the accuracy of the device and hysteresis is also eliminated.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a testing device for a backflow prevention device according to an embodiment of the present invention.

FIG. 2 illustrates a testing device for a backflow prevention device according to an embodiment of the present invention.

FIG. 3 illustrates a detailed view of a backflow prevention device.

FIG. 4 illustrates a schematic view of a method for monitoring fluid pressure in a backflow prevention device according to an embodiment of the present invention.

FIG. 5 illustrates a testing device for Pitot tubes according to an embodiment of the present invention.

### DESCRIPTION OF EMBODIMENTS

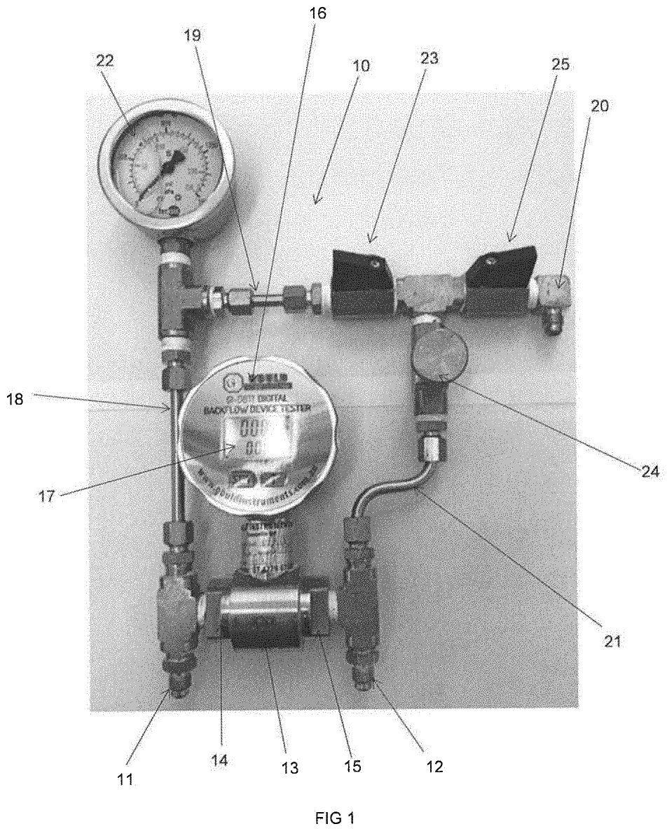

FIG. 1 illustrates a testing device 10 for a backflow prevention device according to an embodiment of the present invention. The testing device 10 includes a first connection portion 11 adapted for connection to a high pressure side or a low pressure side of a backflow prevention device (not shown) and a second connection portion 12 adapted for connection to the other of the high pressure side or the low pressure side of the backflow prevention device (not shown).

A portion of the fluid entering the device 10 through the first connection portion 11 and the second connection portion 12 is directed to the measurement portion 13. The measurement portion 13 comprises a conduit in which a differential pressure transducer (obscured) is positioned. Fluid entering the testing device 10 through the first connection portion 11 enters the measurement portion 13 through a first end 14 thereof, while fluid entering the testing device 10 through the second connection portion 12 enters the measurement portion 13 through an opposed second end thereof 15. In the embodiment of the invention shown in FIG. 1, the differential pressure transducer (obscured) is positioned substantially half ways between opposed ends 14, 15 of the measurement portion 13.

The differential pressure transducer (obscured) is located within the measurement portion 13 so as to substantially preclude the flow of liquid past the differential pressure transducer in either direction. Instead, the differential pressure transducer measures the difference in fluid pressure between the fluid entering from the first end 14 of the measurement portion 13 and fluid entering from the second end 15 of the measurement portion 13.

The differential pressure transducer (obscured) is electronically connected to a calculation portion of the electronic differential pressure gauge 16 so that differential pressure measurements measured by the differential pressure transducer (obscured) is electronically communicated to the electronic differential pressure gauge 16 for calculation and/or conversion and display on the electronic display 17 of the electronic differential pressure gauge 16 and, optionally, transmission to an electronic device (not shown).

Fluid entering the first connection portion 11 flows through conduits 18, 19 towards the outlet portion 20, while fluid entering the second connection portion 12 flows through conduit 21 towards the outlet portion 20. An analogue pressure gauge 22 is associated with the first connection portion 11 such that the pressure of the fluid entering the testing device 10 through the first connection portion 11 may be measured. By measuring the pressure of the fluid entering the device 10 through the first connection portion 11 and the differential fluid pressure, the pressure of the fluid entering the device 10 through the second connection portion 12 may be calculated if required.

A valve 23 is located on conduit 19 and may be used to prevent fluid entering the device 10 through the first connection portion 11 from flowing to the outlet portion 20. Similarly, a valve 24 is located on conduit 21 and may be used to prevent fluid entering the device 10 through the second connection portion 12 from flowing to the outlet portion 20.

A further valve 25 is associated with the outlet portion 20 and may be used to retain fluid within the testing device 10 during use.

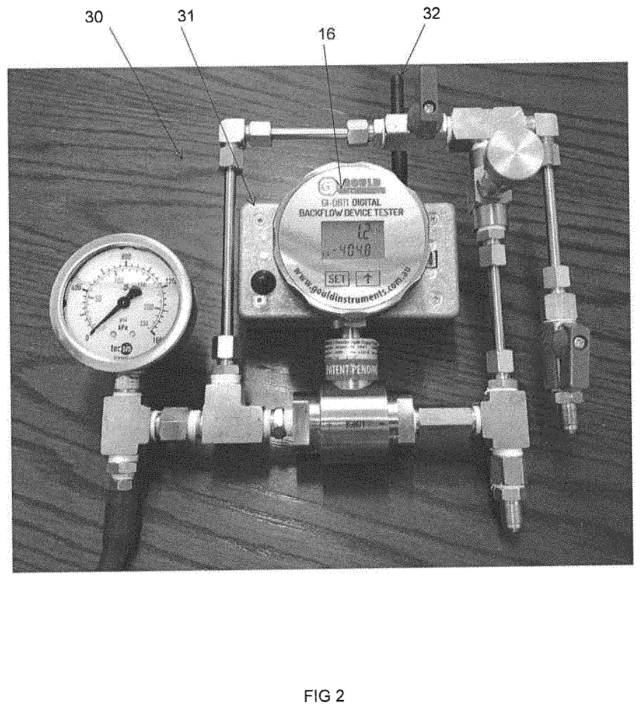

FIG. 2 illustrates a testing device 30 for a backflow prevention device according to an embodiment of the present invention. The testing device 30 is very similar to that illustrated in FIG. 1, with the exception that the testing device 30 includes a wireless connection device 31 in electronic communication with the electronic differential pressure gauge 16. The wireless connection device 31 is adapted to allow one or more electronic devices (not shown) to receive the measured differential pressures from the electronic differential pressure gauge 16. In this embodiment, the wireless connection device 31 is in electronic communication with the electronic differential pressure gauge 16 via one or more wires or cables (obscured).

The wireless connection device 31 of FIG. 2 includes a router (obscured) and a transmitting device in the form of an antenna 32. The antenna 32 wirelessly transmits the measured differential pressures to the electronic device (not shown).

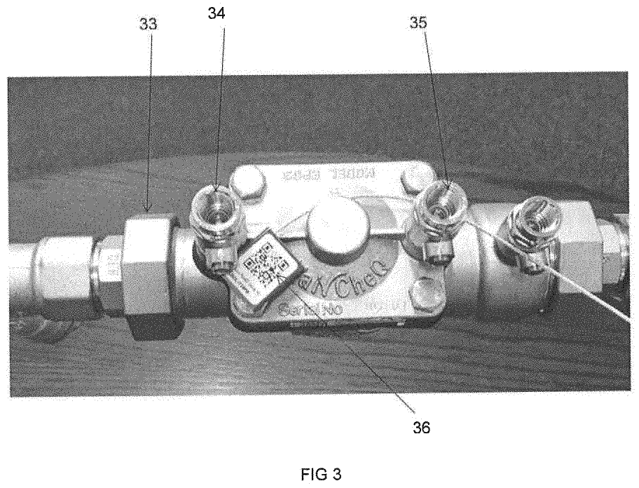

FIG. 3 illustrates a detailed view of a backflow prevention device 33. The backflow prevention device 33 includes a first test cock 34 on a high pressure side of the device 33 and a second test cock 35 on a low pressure side of the device 33. In use, it is envisaged that the first connection portion and the second connection portion of the testing device (not shown in this Figure) will be connected to the first test cock 34 and the second test cock 35.

An identifier 36 in the form of a tag bearing a QR code is connected to the backflow prevention device 33. In use, a user will enter the identifier 36 scan the identifier 36 into an electronic backflow prevention device testing system (not shown) by scanning the identifier with an electronic device (not shown) such as a mobile telephone, computing tablet or the like. In this way, differential pressure measurements measured by the testing device (not shown in this Figure) may be received on the electronic device (not shown), and therefore entered into the electronic backflow prevention device testing system, from the wireless connection portion (not shown in this Figure) of the testing device (not shown in this Figure).

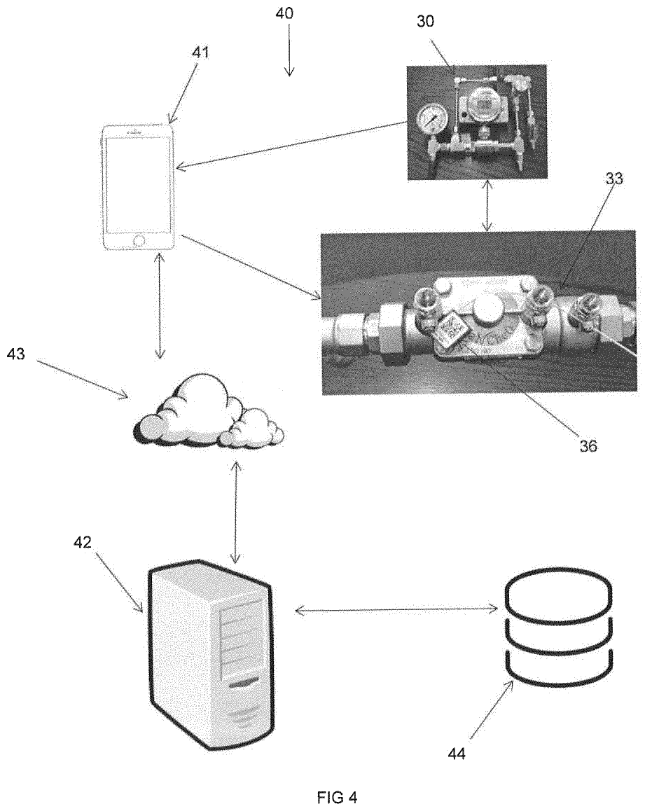

FIG. 4 illustrates a schematic view of a method 40 for monitoring fluid pressure in a backflow prevention device according to an embodiment of the present invention. In this Figure, a testing device 30 is connected to a backflow prevention device 33. A user scans an identifier 36 associated with the backflow prevention device 33 using an electronic device 41.

The electronic device 41 is in electronic communication with a server 42 via the Internet 43. When the user scans the identifier 36 with the electronic device 41, the identifier is sent to the server 42. The server is in electronic communication with a database 44 containing electronic records associated with one or more backflow prevention devices, with each backflow prevention device being assigned a unique identifier. Thus, upon receipt of the identifier 36, the server 42 retrieves the electronic record associated with the backflow prevention device 33 and electronically communicates this to the electronic device 41.

The testing device 30 measures differential pressure in the backflow prevention device and transmits the differential pressure measurements to the electronic device 41. The differential pressure measurements are used to create an updated electronic record that is transmitted to the server 42 by the electronic device 41. When the user confirms that the differential pressure measurements are acceptable, accurate and/or correct, the updated electronic record is written to the database 44 by the server 42.

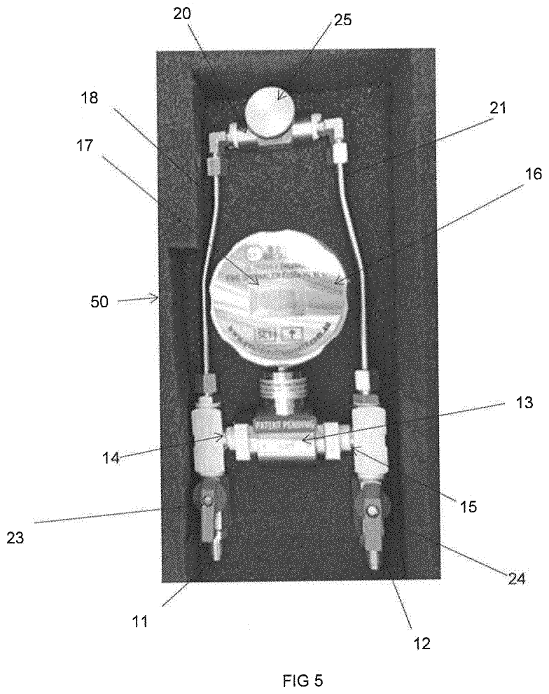

FIG. 5 illustrates a testing device 50 for Pitot tubes according to an embodiment of the present invention. The testing device 50 includes a first connection portion 11 adapted for connection to a high pressure side or a low pressure side of a Pitot tube (not shown) and a second connection portion 12 adapted for connection to the other of the high pressure side or the low pressure side of the Pitot tube (not shown).

A portion of the fluid entering the device 10 through the first connection portion 11 and the second connection portion 12 is directed to the measurement portion 13. The measurement portion 13 comprises a conduit in which a differential pressure transducer (obscured) is positioned. Fluid entering the testing device 50 through the first connection portion 11 enters the measurement portion 13 through a first end 14 thereof, while fluid entering the testing device 50 through the second connection portion 12 enters the measurement portion 13 through an opposed second end thereof 15. In the embodiment of the invention shown in FIG. 1, the differential pressure transducer (obscured) is positioned substantially half ways between opposed ends 14, 15 of the measurement portion 13.

The differential pressure transducer (obscured) is located within the measurement portion 13 so as to substantially preclude the flow of liquid past the differential pressure transducer in either direction. Instead, the differential pressure transducer measures the difference in fluid pressure between the fluid entering from the first end 14 of the measurement portion 13 and fluid entering from the second end 15 of the measurement portion 13.

The differential pressure transducer (obscured) is electronically connected to a calculation portion of the electronic differential pressure gauge 16 so that differential pressure measurements measured by the differential pressure transducer (obscured) is electronically communicated to the electronic differential pressure gauge 16 for calculation and/or conversion (such as to kPa or inHg) and display on the electronic display 17 of the electronic differential pressure gauge 16.

Fluid entering the first connection portion 11 flows through conduit 18 towards the outlet portion 20, while fluid entering the second connection portion 12 flows through conduit 21 towards the outlet portion 20.

A valve 23 is located on conduit 18 and may be used to prevent fluid entering the device 50 through the first connection portion 11. Similarly, a valve 24 is located on conduit 21 and may be used to prevent fluid entering the device 50 through the second connection portion 12.

A further valve 25 is associated with the outlet portion 20 and may be used to retain fluid within the testing device 50 during use.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A testing device for backflow prevention devices, the testing device comprising a first connection portion adapted for removable connection to one of a high pressure side or a low pressure side of a backflow prevention device, a second connection portion adapted for removable connection to the other of the high pressure side or the low pressure side of the backflow pressure device, and an electronic differential pressure gauge positioned in fluid communication with the first connection portion and the second connection portion and adapted to measure the differential pressure between the high pressure side and the low pressure side of the backflow prevention device.

2. The testing device according to claim 1 wherein the testing device further comprises a pressure gauge associated with the first connection portion and adapted to measure fluid pressure at the side of the backflow prevention device to which the first connection portion is attached.

3. The testing device according to claim 1 wherein fluid flows from the backflow prevention device into the testing device through the first connection portion and the second connection portion.

4. The testing device according to claims 1 wherein the electronic differential pressure gauge is associated with a measurement portion of the testing device.

5. The testing device according to claim 4 wherein at least a portion of the fluid entering the testing device through the first connection portion and the second connection portion is directed into a measurement portion of the testing device.

6. The testing device according to claim 1 wherein the electronic differential pressure gauge is provided with one or more differential pressure transducers.

7. The testing device according to claim 6 wherein measurements taken by the one or more pressure transducers are electronically communicated to a calculation portion of the electronic differential pressure gauge.

8. The testing device according to claim 1 wherein the electronic differential pressure gauge includes an electronic display.

9. The testing device according to claim 1 wherein the testing device is provided with a wireless connection device.

10. The testing device according to claim 9 wherein the wireless connection device is in electronic communication with the electronic differential pressure gauge.

11.The testing device according to claim 9 wherein the differential pressure measured by the electronic differential pressure gauge is transmitted by the wireless connection device to an electronic device associated with a user.

12. A testing device for backflow prevention devices, the testing device comprising a first connection portion adapted for removable connection to one of a high pressure side or a low pressure side of backflow prevention device, a second connection portion adapted for removable connection to the other of the high pressure side or the low pressure side of the backflow pressure device, and an electronic differential pressure gauge positioned in fluid communication with the first connection portion and the second connection portion and adapted to measure the differential pressure between the high pressure side and the low pressure side of the backflow prevention device, wherein the testing device is provided with a wireless connection device, and wherein the differential pressure measured by the electronic differential pressure gauge is transmitted by the wireless connection device to an electronic device associated with a user.

13. A testing device when used for testing Pitot tubes located in a conduit of a fire sprinkler system, the testing device comprising a first connection portion adapted for removable connection to one of a high pressure side or a low pressure side of a Pitot tube, a second connection portion adapted for removable connection to the other of the high pressure side or the low pressure side of the Pitot tube, and an electronic differential pressure gauge positioned in fluid communication with the first connection portion and the second connection portion and adapted to measure the differential pressure between the high pressure side and the low pressure side of the Pitot tube.

14. The testing device according to claim 13 wherein the Pitot tube is an annubar averaging Pitot tube.

15. A method for monitoring fluid pressure in a backflow prevention device, the method including the steps of:
a. Connecting a testing device to the backflow prevention device, the testing device including an electronic differential pressure gauge;
b. Entering, using an electronic device associated with a user, an identifier associated with the backflow prevention device into an electronic backflow prevention device testing system;
c. Receiving, with the electronic device, one or more differential pressure measurements generated by the electronic differential pressure gauge;
d. Entering the one or more differential pressure measurements into an electronic record associated with the backflow prevention device to create an updated electronic record; and
e. Writing the updated electronic record to an electronic database associated with the electronic backflow prevention device testing system.

16. A method for monitoring fluid pressure in a backflow prevention device according to claim 15 wherein the testing device comprises the testing device.

17. (canceled)
